(19) United States
(12) Patent Application Publication
(10) Pub. No.: US 2017/0314518 A1
(43) Pub. Date: Nov. 2, 2017

(54) ELECTRONICALLY CONTROLLED GASOLINE GASIFICATION APPARATUS

(71) Applicant: Qianli XU, Shanghai (CN)

(72) Inventor: Qianli XU, Shanghai (CN)

(21) Appl. No.: 15/520,408

(22) PCT Filed: Oct. 26, 2015
(86) PCT No.: PCT/CN2015/092804

§ 371 Date: Apr. 19, 2017

(30) Foreign Application Priority Data
Oct. 27, 2014 (CN) 201410580786.9

(51) Int. Cl. F02M 31/18; F02M 37/00; F02M 31/125

(52) U.S. Cl. CPC F02M 31/183; F02M 31/125; F02M 37/0047

(57) ABSTRACT

A gasoline gasification apparatus comprising a gasifier housing (1). An electronic control fuel inlet nozzle (2) is mounted on the gasifier housing (1). One end of the electronic control fuel inlet nozzle (2) is connected to a gasoline feed pipe (7). The other end of the electronic control fuel inlet nozzle (2) is in communication with a cavity (3) of the gasifier housing (1). An electric heating component (4) is mounted in the cavity (3). A vapor outlet (5) is provided on the cavity (3). The electric heating component (4) mounted in the cavity (3) is connected to a controllable power source (6). This gasoline gasifier apparatus sublimates injected gasoline droplets into gaseous state, thus allowing gasoline molecules to come into complete contact with oxygen, ensuring complete combustion of gasoline in an engine, and reducing emission of pollutants.

### TECHNICAL FIELD

The present invention relates to a gasoline gasification apparatus for a gasoline internal combustion engine.

### BACKGROUND

At present, the thermal efficiency of gasoline internal combustion engine is only about 30%, one of the reasons for the low thermal efficiency is that part of the gasoline are not able to generate power by burning, the unburnt gasoline is gaseous hydrocarbons discharged from the internal combustion engine. In the prior art, the gasoline is atomized into the cylinder through the nozzle, regardless of the nozzle atomization effect, the gasoline atomized into the cylinder is small particle, and the particles particle are unable to fully contact with air, resulting in an incomplete combustion. Therefore, it is urgent to develop a device capable of sufficiently burning the gasoline in the cylinder in order to improve the mechanical thermal efficiency and reduce the exhaust gas emissions from the internal combustion engine.

### SUMMARY

The object of the present invention is to provide a gasoline gasification apparatus, to solve the problem in the prior art that the gasoline is not able to be fully burned. The present invention disclose a gasoline gasification apparatus, comprising a gasifier housing, an electronic control fuel inlet nozzle is mounted on the gasifier housing, one end of the electronic control fuel inlet nozzle is connected to a gasoline feed pipe, the other end of the electronic control fuel inlet nozzle is in communication with an inner cavity of the gasifier housing, an electric heating component is mounted in the inner cavity, a vapor outlet is provided on the cavity. The electric heating component mounted in the cavity is connected to a controllable power source.

The invention has the advantages of using the principle of the gasification of gasoline, sublimating the injected gasoline particle into gas. Since the gasified gasoline is the smallest form of the gasoline molecular group, it is possible to achieve the most complete contact of the gasoline molecules and oxygen. At this time, under the same conditions, the combustion of the gasoline in engine cylinder can be maximized, thus achieving a most adequate combustion and a minimal pollution emissions.

### BRIEF DESCRIPTION OF THE DRAWINGS

The FIGURE is a schematic view of the structure of a gasoline gasification apparatus according to the present invention.

### DETAILED DESCRIPTION OF THE EMBODIMENT

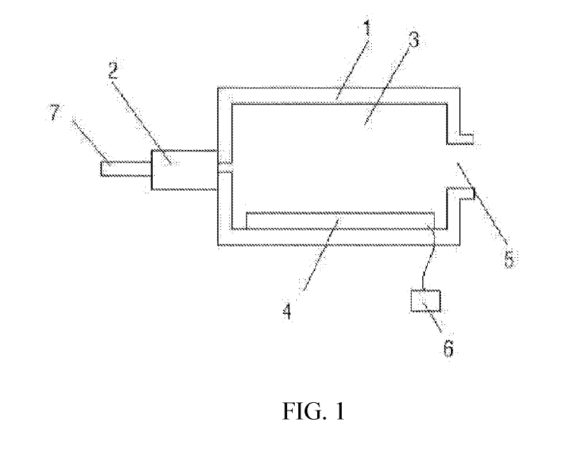

The gasoline gasification apparatus in FIG. 1 comprises a gasifier housing 1, wherein an electronic control fuel inlet nozzle 2 is mounted on the gasifier housing 1, one end of the electronic control fuel inlet nozzle 2 is connected to a gasoline feed pipe 7, the other end of the electronic control fuel inlet nozzle 2 is in communication with an inner cavity 3 of the gasifier housing, an electric heating component 4 is mounted in the inner cavity 3, a vapor outlet 5 is provided on the inner cavity 3. The electric heating component 4 mounted in the inner cavity 3 is connected to a controllable power source 6.

When used, the gasoline is pumped out of the tank through the oil pump, and is injected into the electronic control fuel inlet nozzle via the oil pipe from the gasoline feed pipe 7, then the gasoline is injected into the cavity of the gasifier housing and is gasified by heating in the cavity. The gaseous gasoline is exported from the vapor outlet, then is injected into the internal combustion engine so as to mix with air, the mixture gas is sucked into the cylinder, then the process of compression, ignition, explosion and exhaust are proceeded in turn, the four stroke work is completed. The controllable power source 6 provides electrical energy to the heating element.

The present invention aims to improve the combustion effect of gasoline by increasing the oxidation reaction rate of the hydrocarbon. The principle of the gasoline engine is: injecting gasoline into the cavity of the gasifier housing through the electronic control fuel inlet nozzle, the injected gasoline in gasified in the cavity, then the gasified gasoline is injected into the cylinder of the engine to be burned. The gaseous gasoline in the cylinder is mixed with air at a ratio of about 1:14, followed by compression and explosion (oxidation reaction) to complete the operation of the gasoline engine. The chemical reaction equation is:

2C₈H₁₈+25O₂ . . . 16Co₂+18H₂O

The chemical equation shows that the working level of the gasoline engine depends on the chemical oxidation rate of gasoline.

What is claimed is:

1. A gasoline gasification apparatus, comprising a gasifier housing, wherein an electronic control fuel inlet nozzle is mounted on the gasifier housing, one end of the electronic control fuel inlet nozzle is connected to a gasoline feed pipe, the other end of the electronic control fuel inlet nozzle is in communication with an inner cavity of the gasifier housing, an electric heating component is mounted in the inner cavity, a vapor outlet is provided on the cavity.

2. A gasoline gasification apparatus according to claim 1, wherein the electric heating component mounted in the cavity is connected to a controllable power source.
